(19) United States
(12) Patent Application Publication
(10) Pub. No.: US 2010/0042723 A1
(43) Pub. Date: Feb. 18, 2010

(54) METHOD AND SYSTEM FOR MANAGING LOAD IN A NETWORK

(76) Inventors: Srikanth Sundarrajan, Chennai (IN); Hariprasad Nellitheertha, Bangalore (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/539,699

(22) Filed: Aug. 12, 2009

(30) Foreign Application Priority Data
Aug. 12, 2008 (IN) 1953/CHE/2008

(51) Int. Cl. G06F 15/16

(52) U.S. Cl. 709/226

(57) ABSTRACT

A method for managing load in a network comprising a first set of hosts, a second set of hosts and a centralized server is provided. A virtual machine runs on each of the first set of hosts. The centralized server receives resource donation information from each of the second set of hosts that are underutilized. Further, a load surge indicating additional tasks to be performed by the first set of hosts and the second set of hosts is identified. Next, the centralized server negotiates with the second set of hosts for modification of the resource donation information. Thereafter, one or more hosts are determined, based on the resource donation information and the load surge. These hosts create a virtual machine, based on the resource donation information, and become a part of the first set of hosts. The centralized server delegates the additional tasks among the first set of hosts.

### BACKGROUND OF THE INVENTION

The invention relates to the field of networks. More specifically, the invention relates to a method and system for managing load in a network.

A network includes a plurality of data processing units which can communicate with each other. A data processing unit is a device that processes information after it has been encoded into data. Examples of data processing units include computers, Personal Digital Assistants (PDAs), laptops, mobile phones, and the like. The network also includes a dedicated server that can communicate with the plurality of data processing units. The dedicated server maintains the shared network data that can be accessed by the plurality of data processing units. The dedicated server is also responsible for allocation of tasks among the plurality of data processing units.

A network generally experiences an increase or decrease in load. For example, there may be an increase in load in the network for specific duration of time in a day. Such increase in load is referred to as a load surge. The load surge indicates additional tasks to be performed by the data processing units in the network. These load surges can be planned or unplanned. When there is a sudden surge in the load, the existing capacity of the data processing units in the network may not be sufficient to handle the load surge. In such a scenario, applications running on these data processing units can degrade in performance, and may eventually crash. As a result, the additional tasks need to be distributed among the data processing units in the network.

There exist methods that address the problem of handling a load surge in a network. One of these methods involves creation of a virtual server on a data processing unit in the network. The method also involves monitoring the resource information of the virtual server and identifying overload of the virtual server. Further, the resource information of the virtual server is modified. Finally, the method involves transferring the virtual server to another data processing unit in the network.

However, the methods mentioned above have one or more of the following limitations. First, a virtual server is transferred from one data processing unit to another. Such a transfer may involve a lot of time and effort. Further, such a transfer may not be feasible in the event of a sudden load surge when a large number of virtual machines need to be transferred. Second, these methods require users to plan in advance and configure the network, particularly the dedicated server, so that it can handle the anticipated load surge. As a result, over a period of time, the average utilization of the resources in the network is low. Finally, if the buffer of existing resources is insufficient, it may not be possible to handle an unanticipated load surge.

In light of the above, there is a need for a method and system for managing load in a network. The new method should maintain a sufficient buffer to ensure that the network is able to handle a load surge. Further, the new method should eliminate the transfer of a virtual machine from one data processing unit to another. Finally, the new method should not require customers to plan in advance for an anticipated load surge, thereby achieving optimal utilization of resources in the network.

### SUMMARY OF THE INVENTION

An object of the invention is to provide a method, system and computer program product for managing load in a network in the event of load surges.

Another object of the invention is to provide a method for managing load in a network by collaborative sharing of computational resources through resource donation.

Yet another object of the invention is to provide improved and uninterrupted user experience by seamless creation of virtual machines in a network.

To achieve the objectives mentioned above, the invention provides a method for managing load in a network comprising a first set of hosts, a second set of hosts and a centralized server. The second set of hosts is underutilized. A virtual machine runs on each of the first set of hosts. The method at the centralized server comprises receiving resource donation information from each of the second set of hosts. Each of the second set of hosts registers the resource donation information with the centralized server. Further, a load surge in the network is identified. The load surge indicates additional tasks to be performed by the first set of hosts and the second set of hosts. Next, the centralized server negotiates with the second set of hosts for modification of the resource donation information.

The method further comprises determining one or more hosts from the second set of hosts. The one or more hosts are determined based on the resource donation information received from each of the second set of hosts and the identified load surge. Here, each of the one or more hosts creates a virtual machine based on the resource donation information. These one or more hosts become a part of the first set of hosts. Finally, the additional tasks are delegated by the centralized server among the first set of hosts.

Consequently, the invention described above advantageously creates virtual machines on the hosts that are underutilized, during a load surge, to distribute the additional load. The virtual machines are created, based on the resource donation committed by the underutilized hosts to the centralized server. Further, the resource donation committed by a host to the centralized server is not binding on that host. Furthermore, the invention enables the centralized server to efficiently identify extra resources in the network and utilize these resources by creating additional virtual machines, thereby managing the load. In addition, the centralized server facilitates seamless creation of virtual machines during a load surge, without the knowledge of the users, providing improved user experience and uninterrupted service.

### BRIEF DESCRIPTION OF THE DRAWINGS

Various embodiments of the invention will hereinafter be described in conjunction with the appended drawings, provided to illustrate, and not to limit, the invention, wherein like designations denote like elements, and in which:

FIG. 1 is a network where various embodiments of the invention can be practiced;

FIG. 2 is a block diagram illustrating a centralized server to manage load in the network, in accordance with an embodiment of the invention;

FIG. 3 is a block diagram illustrating a host in the network, in accordance with an embodiment of the invention;

FIG. 4 is a flowchart illustrating a method for managing load in the network, in accordance with an embodiment of the invention; and

FIGS. 5A and 5B is a flowchart illustrating a method for managing load in the network, in accordance with another embodiment of the invention.

### DETAILED DESCRIPTION

Before describing the embodiments in detail, in accordance with the invention, it should be observed that the embodiments reside primarily in the method and system employed for managing load in a network. Accordingly, the system components and method steps have been represented to only illustrate those specific details that are pertinent to understanding the embodiments of the invention, and not the details that will be apparent to those of ordinary skill in the art.

The invention describes a method for managing load in a network. The network includes a first set of hosts, a second set of hosts and a centralized server. The second set of hosts are underutilized. A virtual machine runs on each of the first set of hosts. The method at the centralized server includes receiving resource donation information from each of the second set of hosts. Each of the second set of hosts registers the resource donation information with the centralized server. Further, the method includes identifying a load surge in the network. The load surge indicates additional tasks to be performed by the first set of hosts and the second set of hosts. The method includes negotiating with the second set of hosts for modification of the resource donation information. The method further comprises determining one or more hosts from the second set of hosts. The one or more hosts are determined, based on the resource donation information received from each of the second set of hosts and the identified load surge. Each of the one or more hosts creates a virtual machine based on the resource donation information. These one or more hosts become a part of the first set of hosts. The method also comprises delegating the additional tasks among the first set of hosts.

The invention also describes a centralized server to manage load in a network. The network includes a first set of hosts, a second set of hosts and a centralized server. The second set of hosts are underutilized. A virtual machine runs on each of the first set of hosts. The centralized server includes a resource donation agent that is configured to receive resource donation information from each of the second set of hosts. The resource donation information is registered with a database. The centralized server further includes a load balancer that is configured to identify a load surge in the network. The load surge indicates additional tasks to be performed by the first set of hosts and the second set of hosts. The centralized server also includes a scheduling manager. The scheduling manager is configured to negotiate with the second set of hosts when the load surge has been identified. The scheduling manager negotiates for modification of the resource donation information. Further, the scheduling manager is configured to determine one or more hosts from the second set of hosts, based on the resource donation information and the identified load surge. Each of the one or more hosts creates a virtual machine, based on the resource donation information that is associated with each of the second set of hosts. Furthermore, the one or more hosts become a part of the first set of hosts. The scheduling manager is also configured to delegate the additional tasks among the first set of hosts.

The invention also describes a host connected in a network. The host includes a resource agent that is configured to compute the resource donation information. The resource donation information indicates the resources that the host is ready to contribute. The resource agent is further configured to register the resource donation information with a centralized server. Further, the host includes an operation agent that is configured to create a virtual machine on the host, based on the resource donation information. The operation agent creates the virtual machine, based on the instructions received from the centralized server.

The invention also describes a computer program product for managing load in a network. The network includes a first set of hosts, a second set of hosts and a centralized server. The second set of hosts is underutilized. A virtual machine runs on each of the first set of hosts. The computer program product includes a computer usable medium that includes a computer program code which performs the step of receiving resource donation information from each of the second set of hosts. The host registers the resource donation information with the centralized server. The computer program code also performs the step of identifying a load surge in the network. The load surge indicates additional tasks to be performed by the first set of hosts and the second set of hosts. Further, the computer program code performs the step of negotiating with the second set of hosts when the load surge has been identified. The centralized sever negotiates with the second set of hosts for modification of the resource donation information. The computer program code also performs the step of determining one or more hosts from the second set of hosts, based on the resource donation information received from each of the second set of hosts and the identified load surge. Each of the one or more hosts creates a virtual machine based on the resource donation information. The one or more hosts become a part of the first set of hosts. The computer program code also performs the step of delegating the additional tasks among the first set of hosts.

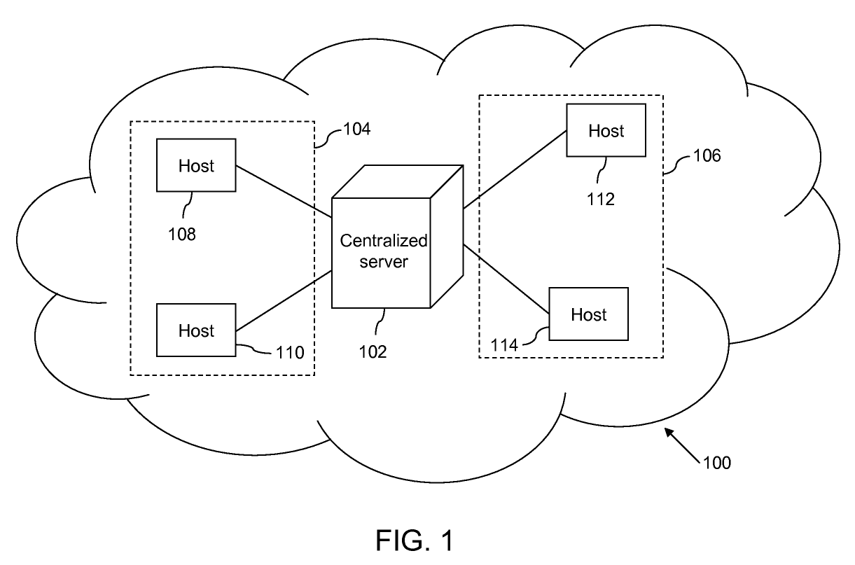

FIG. 1 illustrates a network 100, where various embodiments of the invention can be practiced. Network 100 includes a centralized server 102, a first set of hosts 104 and a second set of hosts 106. Examples of network 100 include, but are not limited to, a Local Area Network (LAN), a Wide Area Network (WAN), and a Grid Network.

Centralized server 102 is communicatively coupled with first set of hosts 104 and second set of hosts 106. Examples of centralized server 102 include, but are not limited to, Windows Sever 2003, RedHat Enterprise Linux Server, and Novell SUSE Enterprise Linux Server. First set of hosts 104 includes a host 108 and a host 110. A virtual machine each runs on host 108 and host 110. A virtual machine is a software implementation of a host that executes tasks like an actual host. Virtual machines enable multiplexing of an underlying host between different virtual machines. Second set of hosts 106 includes a host 112 and a host 114. Hosts 112 and 114 are underutilized. In other words, hosts 112 and 114 have the capacity of performing additional tasks. Although first set of hosts 104 and second set of hosts 106 are shown to include only hosts 108 and 110, and hosts 112 and 114, it will be apparent to a person skilled in the art that first set of hosts 104 and second set of hosts 106 can include a plurality of hosts. Examples of hosts 108, 110, 112 and 114 include, but are not limited to, desktops and laptops.

At a given time, first set of hosts 104, which includes hosts 108 and 110, represent the hosts that are performing the tasks in network 100. Centralized server 102 distributes the tasks among first set of hosts 104. The number of tasks performed represents the load on network 100. Centralized server 102 is responsible for managing the load in network 100. Second set of hosts 106, which includes hosts 110 and 112, represent the hosts that have the capacity to perform additional tasks in network 100. The load on network 100 may increase when additional tasks need to be performed in network 100. Centralized server 102 manages the increase in the load by delegating the additional tasks among first set of hosts 104 and second set of hosts 106.

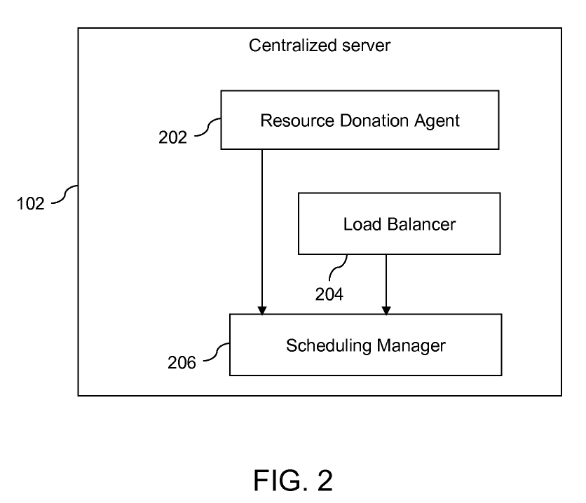

FIG. 2 illustrates centralized server 102 to manage load in network 100, in accordance with an embodiment of the invention. To describe centralized server 102, reference will be made to FIG. 1, although it is understood that centralized server 102 can be implemented with reference to any other suitable embodiment of the invention.

Centralized server 102 includes a resource donation agent 202, a load balancer 204 and a scheduling manager 206. Resource donation agent 202 is configured to receive resource donation information from second set of hosts 106. The resource donation information includes information regarding the resources that a host is capable of contributing. In other words, the resource donation information represents the additional number of tasks that a host is ready to perform. Second set of hosts 106, which includes hosts 110 and 112, calculate their respective resource donation information. This respective resource donation information is registered by host 110 and host 120 with centralized server 102. In an embodiment, the resource donation information is registered with a database. The database may be operatively coupled with centralized server 102.

Load balancer 204 is configured to identify a load surge in network 100. In an embodiment, the load surge indicates the additional tasks to be performed by first set of hosts 104 and second set of hosts 106. An increase in load may be experienced by network 100 when network 100 is required to serve increasing number of requests made by the users of network 100. In an embodiment, load balancer 204 is configured to identify a decrease in the load in network 100. The decrease in the load indicates decrease in the number of tasks to be performed in network 100. In another embodiment, load balancer 204 is an external network component communicatively coupled with centralized server 102.

Scheduling manager 206 is configured to negotiate with second set of hosts 106 when a load surge has been identified by load balancer 204. Scheduling manager 206 negotiates with second set of hosts 106 for modification of the resource donation information of hosts 112 and 114. Second set of hosts 106 can modify the resource donation information, with the database indicating the changes in the resources, which second set of hosts 106 are capable of contributing.

Scheduling manager 206 is further configured to determine one or more hosts from second set of hosts 106, based on the resource donation information and the identified load surge. In other words, scheduling manager 206 can determine some hosts from second set of hosts 106 that can serve additional tasks associated with the load surge, depending on the extent of the load surge and the availability of resources with second set of hosts 106. Further, scheduling manager 206 instructs each of the one or more hosts to create a virtual machine, based on their respective resource donation information. Furthermore, these one or more hosts are identified as a part of first set of hosts 104. For example, in the event of a load surge, scheduling manager 206 can identify host 112 from second set of hosts 106, based on the resource donation information of second set of hosts 106. Host 112 then creates a virtual machine, based on its resource donation information. Host 112 is now identified as a part of first set of hosts 104. Scheduling manager 206 is also configured to delegate additional tasks associated with the load surge among first set of hosts 104, which includes host 112. These additional tasks are performed by the virtual machines present on first set of hosts 104.

In an embodiment, scheduling manager 206 is configured to terminate a virtual machine present on at least one host from first set of hosts 104. Typically, virtual machines are terminated when there is a decrease in the load in network 100. For example, scheduling manager 206 terminates a virtual machine present on host 110 from first set of hosts 104. In an embodiment, in order to terminate a virtual machine on host 110, scheduling manager 206 instructs host 110 to terminate the virtual machine present on host 110. While terminating the virtual machine, resources associated with the virtual machine on host 110 are released. Further, host 110 is now identified as a part of second set of hosts 106. In another embodiment, termination of a virtual machine on a host also involves modification of the resource donation information of the host.

In an embodiment, resource donation agent 202 is configured to receive the modified resource donation information from hosts 112 and 114, which form a part of second set of hosts 106. The modified resource donation information is re-registered with resource donation agent 202. In another embodiment, the resource donation information of a host is modified by the host when a virtual machine on that host is terminated. For instance, host 112 can modify its resource donation information when the virtual machine on host 112 is terminated.

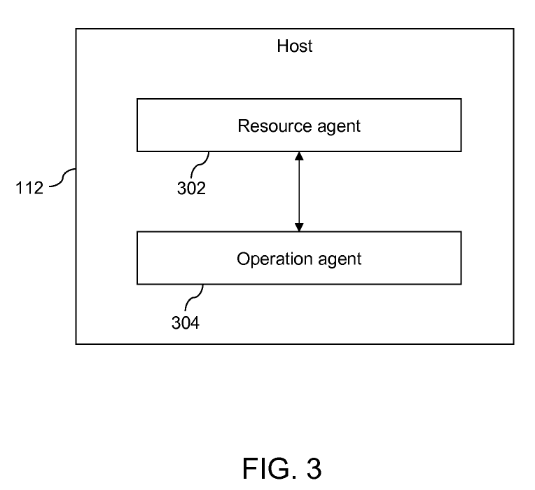

FIG. 3 illustrates host 112 connected in network 100, in accordance with an embodiment of the invention. To describe host 112, reference will be made to FIG. 1, although it is understood that host 112 can be implemented with reference to any other suitable embodiment of the invention.

Host 112 is connected to centralized server 102 through communication links. Examples of communication links include wired communication links, such as fiber optic cables, and wireless communication links, such as Infrared and Bluetooth. Although host 112 is shown to be a part of second set of hosts 106 in FIG. 1, it will be apparent to a person skilled in the art that host 112 can be any of hosts 108, 110, 112 and 114. Host 112 includes a resource agent 302 and an operation agent 304. Resource agent 302 is configured to compute its own resource donation information. The resource donation information includes information regarding the resources that a host is capable of contributing. In an embodiment, resource agent 302 calculates its resource donation information at a predefined time interval. Resource agent 302 is further configured to register the resource donation information of host 112 with centralized server 102. In an embodiment, the resource donation information is registered with centralized server 102 at a predefined time interval.

Operation agent 304 is configured to create a virtual machine on host 112, based on the resource donation information of host 112. In an embodiment of the invention, operation agent 304 creates the virtual machine, based on instructions received from centralized server 102. Typically, operation agent 304 creates the virtual machine when an increase in load is experienced in network 100. The virtual machine caters to a part of the additional tasks associated with the increase in load in network 100. In another embodiment, operation agent 304 is configured to terminate the virtual machine. Typically, the virtual machine is terminated by operation agent 304 when a decrease in load is experienced in network 100.

In an embodiment of the invention, resource agent 302 is configured to modify the resource donation information when the virtual machine on host 112 is terminated. Resource agent 302 is further configured to re-register the modified resource donation information with centralized server 102.

In an embodiment, resource agent 302 is configured to release the resources associated with the resource donation information of host 112. Typically, the resources are released when the virtual machine on host 112 is terminated.

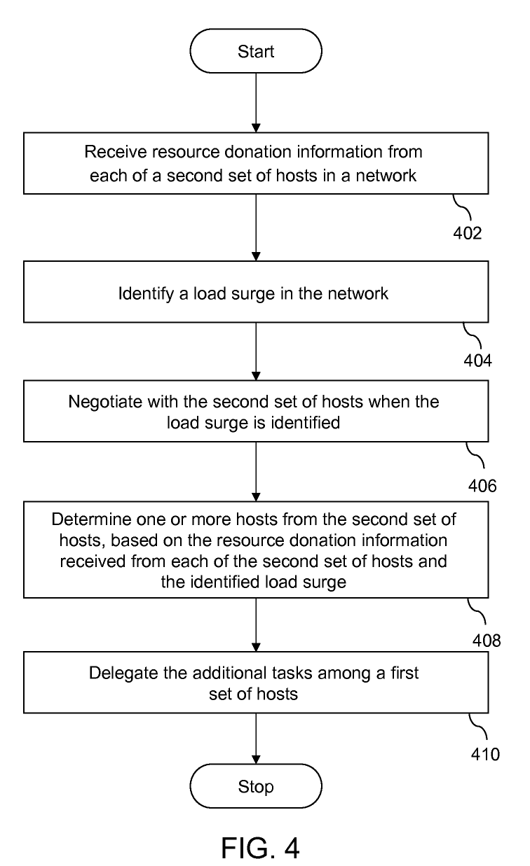

FIG. 4 is a flow diagram illustrating a method for managing load in network 100, in accordance with an embodiment of the invention. To describe the method, reference will be made to FIG. 1, although it is understood that the method can be implemented with reference to any other suitable embodiment of the invention. Further, the method can contain a greater or fewer number of steps than shown in FIG. 4.

At step 402, resource donation information is received by centralized server 102 from each host of second set of hosts 106, that is, hosts 112 and 114. The resource donation information for hosts 112 and 114 is registered with centralized server 102. Typically, the resource donation information is registered with centralized server 102 at a predefined time interval. At step 404, a load surge is identified in network 100 by centralized server 102. The load surge indicates the additional tasks to be performed by first set of hosts 104 and second set of hosts 106. An increase in load on network 100 may be experienced when it is required to serve increasing number of requests made by the users of network 100. At step 406, when the load surge is identified, centralized server 102 negotiates with second set of hosts 106 for modification of the resource donation information of second set of hosts 106. Typically, centralized server 102 negotiates with second set of hosts 106, which includes hosts 112 and 114, to determine whether there is a change in the resource donation information of hosts 112 and 114.

At step 408, one or more hosts are determined from second set of hosts 106 by centralized server 102, based on the resource donation information received from second set of hosts 106 and the identified load surge. Each of the one or more hosts creates a virtual machine, based on its own resource donation information. Further, these one or more hosts are now identified as a part of first set of hosts 104. For Instance, centralized server 102 can identify host 112, based on the resource donation information of host 112 and the load surge. In this event, host 112 creates a virtual machine based on its own resource donation information. Host 112 is now identified as a part of first set of hosts 104. In other words, first set of hosts 104 now includes hosts 108, 110 and 112. Finally, at step 410, the additional tasks are delegated by centralized server 102 among first set of hosts 104. These additional tasks are performed by the virtual machines running on first set of hosts 104.

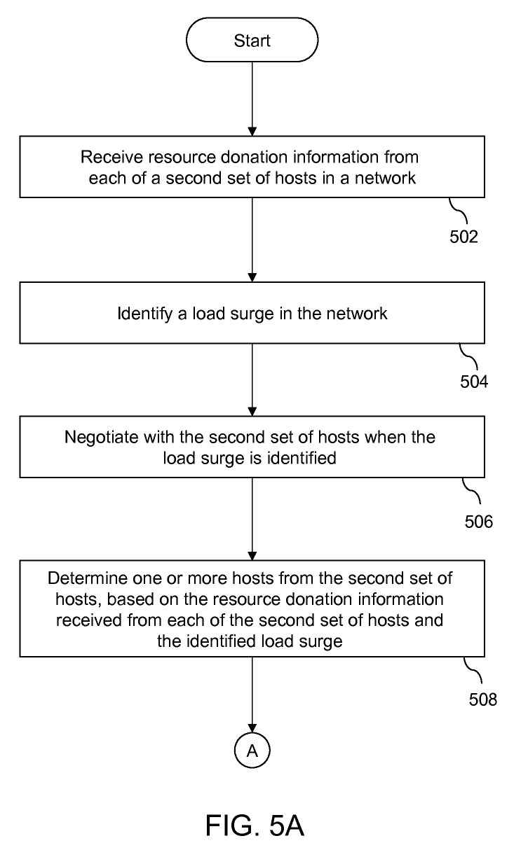

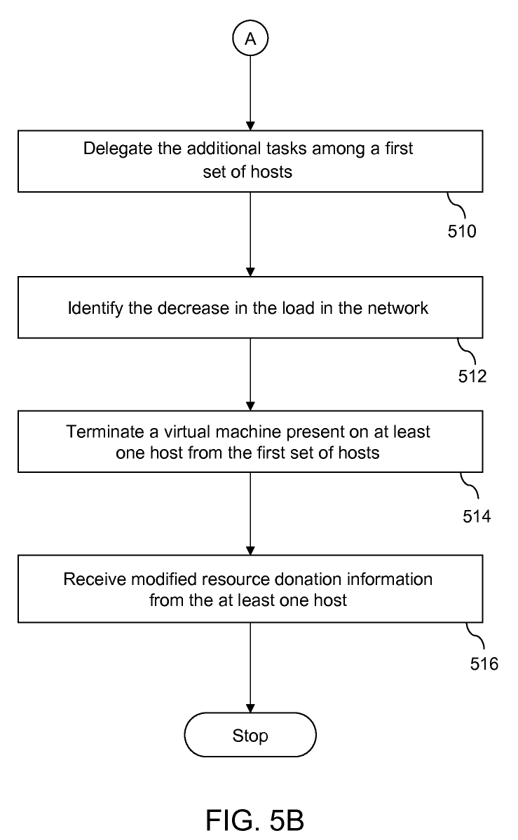

FIGS. 5A and 5B illustrate a flow diagram of a method for managing load in network 100, in accordance with another embodiment of the invention. To describe the method, reference will be made to FIGS. 1, 2 and 3, although it is understood that the method can be implemented with reference to any other suitable embodiment of the invention. Further, the method can contain a greater or fewer number of steps than shown in FIGS. 5A and 5B.

At step 502, resource donation information is received by centralized server 102 from each host of second set of hosts 106, that is, hosts 112 and 114. Typically, the resource donation information is received by resource donation agent 202 of centralized server 102. In an embodiment, resource donation information is calculated by a host. For example, host 112 calculates its resource donation information. Typically, the resource donation information of host 112 is calculated by resource agent 302. Further, resource agent 302 registers the resource donation information with centralized server 102. In an embodiment, the resource donation information is registered with a database that is operatively coupled with centralized server 102.

At step 504, a load surge is identified in network 100 by centralized server 102. The load surge indicates additional tasks to be performed by first set of hosts 104 and second set of hosts 106. An increase in load may be experienced by network 100 when network 100 is required to serve increasing number of requests made by the users of network 100. Typically, the load surge is identified by load balancer 204 of centralized server 102.

At step 506, when the load surge has been identified, centralized server 102 negotiates with second set of hosts 106 for modification of the resource donation information of second set of hosts 106. In an embodiment of the invention, centralized server 102 negotiates with second set of hosts 106, which include hosts 112 and 114, to determine whether there is a change in the resource donation information of hosts 112 and 114. Typically, scheduling manager 206 of centralized server 102 negotiates with second set of hosts 106 for modification of the resource donation information.

At step 508, one or more hosts are determined from second set of hosts 106 by centralized server 102, based on the resource donation information received from second set of hosts 106 and the identified load surge. Each of the one or more hosts creates a virtual machine based on its own resource donation information. Further, these one or more hosts are now identified as a part of first set of hosts 104. For instance, centralized server 102 can identify host 112, based on the resource donation information of host 112 and the load surge. In this event, host 112 creates a virtual machine based on its own resource donation information. Host 112 is now identified as a part of first set of hosts 104. In other words, first set of hosts 104 now include hosts 108, 110 and 112. Typically, scheduling manager 206 determines the one or more hosts from second set of hosts 106. Further, scheduling manager 206 instructs each of the one or more hosts to create a virtual machine based on their resource donation information. For example, operation agent 304 of host 112 creates a virtual machine based on the instructions received from scheduling manager 206 of centralized server 102.

At step 510, the additional tasks are delegated by centralized server 102 among first set of hosts 104. These additional tasks are performed by the virtual machines running on first set of hosts 104. Typically, scheduling manager 206 delegates the additional tasks among first set of hosts 104. For example, scheduling manager 206 can delegate the additional tasks among hosts 108 and 112. As a result, additional load in network 100 is distributed among first set of hosts 104.

At step 512, a decrease in the load in network 100 is identified by centralized server 102. Typically, the decrease is identified by load balancer 204. The decrease in load indicates a decrease in the number of tasks to be performed in network 100. At step 514, a virtual machine present on at least one host from first set of hosts 104 is terminated by centralized server 102. Typically, the virtual machine is terminated by scheduling manager 206. For example, scheduling manager 206 can terminate the virtual machine present on host 112. In an embodiment of the invention, determination of host 112 for termination of its virtual machine is based on the extent of decrease in load on network 100. When the virtual machine has been terminated, host 112 releases resources associated with the terminated virtual machine. Typically, the resources are released by operation agent 304 of host 112. Further, host 112 modifies its resource donation information when the virtual machine has been terminated. Typically, the resource donation information is modified by operation agent 304.

Finally, at step 516, the modified resource donation information is received by centralized server 102 from the at least one host. Typically, resource donation agent 202 receives the modified resource donation information. For example, the modified resource donation information of host 112 is received by resource donation agent 202.

As described above, the invention advantageously creates virtual machines on the hosts that are underutilized during a load surge, to distribute the additional load. The virtual machines are created based on the resource donation committed by the hosts to the centralized server. Further, the resource donation committed by the host to the centralized server is not binding on that host. Furthermore, the invention enables the centralized server to efficiently identify extra resources in the network and utilize these resources by creating additional virtual machines, thereby managing the load. In addition, the centralized server facilitates seamless creation of virtual machines during a load surge, without the knowledge of the users, providing improved and uninterrupted user experience.

In various embodiments of the invention, the method for managing load in a network may be implemented in the form of software, hardware, firmware, or combinations thereof.

The system for managing load in a network, as described in the invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the invention.

The computer system comprises a computer, an input device, a display unit and the Internet. The computer also comprises a microprocessor, which is connected to a communication bus. It also includes a memory, which may be Random Access Memory (RAM) or Read Only Memory (ROM). Further, the computer system comprises a storage device, which can be a hard disk drive or a removable storage drive, such as a floppy disk drive, an optical disk drive, and the like. The storage device can also be other similar means of loading computer programs or other instructions on the computer system. The computer system includes a communication unit, which enables it to connect to other databases and the Internet through an I/O interface. The communication unit enables transfer and reception of data from other databases. This communication unit may include a modem, an Ethernet card or any similar device that enables the computer system to connect to databases and networks, such as LAN, MAN, WAN and the Internet. The computer system facilitates input from a user through an input device that is accessible to the system through an I/O interface.

The computer system executes a set of instructions, which is stored in one or more storage elements, to process input data. These storage elements may hold data or other information, as desired, and may be in the form of an information source or a physical memory element in the processing machine.

The set of instructions may include various commands that instruct the processing machine to perform specific tasks, such as the steps that constitute the method of the invention. This set of instructions may be in the form of a software program. Further, the software may be in the form of a collection of separate programs, a program module with a long program, or a portion of a program module, as described in the invention. The software may also include modular programming in the form of object-oriented programming. Processing of input data by the processing machine may be in response to users' commands, the results of previous processing, or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for managing load in a network, the network comprising a first set of hosts, a second set of hosts that are under-utilized and a centralized server, a virtual machine running on each of the first set of hosts, the method at the centralized server comprising:
a. receiving resource donation information from each of the second set of hosts, wherein the host registers the resource donation information with the centralized server;
b. identifying a load surge in the network, wherein the load surge indicates additional tasks to be performed by the first set of hosts and the second set of hosts;
c. negotiating with the second set of hosts when the load surge is identified, wherein the centralized sever negotiates with the second set of hosts for modification of the resource donation information;
d. determining one or more hosts from the second set of hosts, based on the resource donation information received from each of the second set of hosts and the identified load surge, wherein each of the one or more hosts creates a virtual machine based on the resource donation information, wherein the one or more hosts become a part of the first set of hosts; and
e. delegating the additional tasks among the first set of hosts.

2. The method according to claim 1, wherein the resource donation information comprises the information regarding the resources the host is capable of contributing.

3. The method according to claim 2, wherein the resource donation information is determined by the host.

4. The method according to claim 1, wherein the resource donation information is stored by the centralized server in a database.

5. The method according to claim 1 further comprising identifying the decrease in the load in the network, wherein the decrease in the load indicates decrease in the number of tasks to be performed.

6. The method according to claim 5 further comprising:
a. terminating the virtual machine present on at least one host from the first set of hosts, wherein the at least one host releases the resources associated with the terminated virtual machine, further wherein the at least one host becomes a part of the second set of hosts; and
b. receiving modified resource donation information from the at least one host, wherein modified resource donation information is re-registered with the centralized server.

7. A centralized server for managing load in a network, the network comprising a first set of hosts and a second set of hosts, a virtual machine running on each of the first set of hosts, the second set of hosts being underutilized, the centralized server comprising:
a. a resource donation agent configured for receiving resource donation information from each of the second set of hosts, wherein the host registers the resource donation information with a database;
b. a load balancer configured for identifying a load surge in the network, wherein the load surge indicates additional tasks to be performed by the first set of hosts and the second set of hosts; and
c. a scheduling manager communicatively coupled to the load balancer wherein the scheduler manager is configured for:
i. negotiating with the second set of hosts when the load surge is identified, wherein the scheduling manager negotiates for the modification the resource donation information;
ii. determining one or more hosts from the second set of hosts, based on the resource donation information and the identified load surge, wherein each of the one or more hosts creates a virtual machine based on the resource donation information associated with each of the second set of hosts, further wherein the one or more hosts become a part of the first set of hosts; and
iii. delegating the additional tasks among the first set of hosts.

8. The centralized server according to claim 7, wherein the resource donation information comprises the information regarding the resources the host capable of contributing.

9. The centralized server according to claim 8, wherein the resource donation information is determined by the host.

10. The centralized server according to claim 7, wherein the load balancer is further configured for identifying the decrease in the load in the network, wherein the decrease in the load indicates decrease in the number of tasks to be performed.

11. The centralized server according to claim 7, wherein the load balancer is an external network component communicatively coupled to the centralized server.

12. The centralized server according to claim 7, wherein the scheduling manager is further configured for terminating the virtual machine present on at least one host from the first set of hosts when decrease in the load in the network is identified, wherein the at least one host releases the resources associated with the terminated virtual machine, further wherein the at least one host becomes a part of the second set of hosts.

13. The centralized server according to claim 7, wherein the resource donation agent is further configured for receiving modified resource donation information from the host, wherein modified resource donation information is re-registered with the resource donation agent, further wherein the host modifies the resource donation information when a virtual machine on the host is terminated.

14. A host connected in a network, the host comprising:
a. a resource agent configured for:
i. computing resource donation information, wherein the resource donation information indicates the resources the host is ready to contribute; and
ii. registering the resource donation information with a centralized server; and
b. an operation agent configured for creating a virtual machine on the host based on the resource donation information, wherein the operation agent creates the virtual machine based on instructions received from the centralized server.

15. The host according to claim 14, wherein the resource donation information is registered with the centralized server at a predefined time interval.

16. The host according to claim 14, wherein the operation agent is further configured for terminating the virtual machine.

17. The host according to claim 14, wherein the resource agent is further configured for:
a. modifying the resource donation information when the virtual machine is terminated; and
b. re-registering the modified resource donation information with the centralized server.

18. The host according to claim 14, wherein the resource agent is further configured for releasing the resources associated with resource donation information of the host.

19. A computer program product for use with a stored program computer, the computer program product comprising a computer usable medium having a computer readable program code embodied therein for managing load in a network, the network comprising a first set of hosts, a second set of hosts that are under-utilized, and a centralized server, a virtual machine running on each of the first set of hosts, the computer readable program code performing the steps of:
a. receiving resource donation information from each of the second set of hosts, wherein the host registers the resource donation information with the centralized server;
b. identifying a load surge in the network, wherein the load surge indicates additional tasks to be performed by the first set of hosts and the second set of hosts;
c. negotiating with the second set of hosts when the load surge is identified, wherein the centralized sever negotiates with the second set of hosts for modification of the resource donation information;
d. determining one or more hosts from the second set of hosts, based on the resource donation information received from each of the second set of hosts and the identified load surge, wherein each of the one or more hosts creates a virtual machine based on the resource donation information, wherein the one or more hosts become a part of the first set of hosts; and
e. delegating the additional tasks among the first set of hosts.

20. The computer readable program code according to claim 19 further performing the step of identifying the decrease in the load in the network, wherein the decrease in the load indicates decrease in the number to tasks to be performed.

21. The computer readable program code according to claim 19 further performing the steps of:
a. terminating the virtual machine present on at least one host from the first set of hosts, wherein the at least one host releases the resources associated with the terminated virtual machine, further wherein the at least one host becomes a part of the second set of hosts; and
b. receiving modified resource donation information from the at least one host, wherein the modified resource donation information is re-registered with the centralized server.
